(19) United States
(12) Patent Application Publication
(10) Pub. No.: US 2006/0196752 A1
(43) Pub. Date: Sep. 7, 2006

(54) Body mount skid assembly

(76) Inventor: Bradley K. Kilby, Burbank, CA (US)

Correspondence Address: GIFFORD, KRASS, GROH, SPRINKLE & CITKOWSKI, P.C, PO BOX 7021, TROY, MI, 48007-7021, US

(21) Appl. No.: 11/361,127

(22) Filed: Feb. 24, 2006

Related U.S. Application Data
(60) Provisional application No. 60/655,788, filed on Feb. 24, 2005.

(51) Int. Cl. B65G 11/00

(52) U.S. Cl. 193/41

(57) ABSTRACT

A body mount skid assembly may include a bracket and a skid plate. The bracket may be positioned on a body mount of a vehicle. The skid plate may then be positioned on the bracket to least partially enclose and protect the body mount. Further, the skid plate may be constructed such that it may be attached to more than one bracket or may enclose more than one body mount.

### CROSS REFERENCE TO RELATED APPLICATIONS

This application claims priority from pending U.S. Provisional Application No. 60/655,788, filed on Feb. 24, 2005 for a Body Mount Skid Assembly.

### BACKGROUND OF THE INVENTION

1. Field of the Invention

The present invention is directed to a vehicle body mount skid assembly. More particularly, the invention is directed to a body mount skid assembly that may include at least one bracket positioned at least one body mount and one or more skid plates that may be positioned on the bracket(s). When installed on a vehicle the skid assembly may operate to protect the body mount of a vehicle from being sheared off or otherwise removed or damaged as may be the case when the vehicle is traveling off-road.

2. Reference to Related Art

Interest and participation in the sport of off-road (or trail) vehicle driving has grown substantially in the last decade. One effect the growth of this sport has had on mainstream markets can be seen in the significant increase of SUV and JEEP® sales during that time. Indeed, interest in the “off-road” experience has been so compelling that the Daimler-Chrysler Corporation has offered so called TRAIL RATED® vehicles directly to the mass market.

However, notwithstanding the efforts of the large automotive manufacturers to bring the off-road experience to the masses, it must be understood that even a true off-road vehicle, such as a JEEP®, must typically undergo at least some degree of after-market modification before it can withstand the physical demands of real off-road terrain. Indeed, without such modifications it is highly likely that a stock “off-road” vehicle would experience significant stress and damage when placed in an extreme off-road environment.

One of the parts of a vehicle that has traditionally been exposed to direct contact with the terrain (and thus damage) are the body mounts. Specifically, in rugged terrain conditions (mountains, rocks, etc.) it is possible for such mounts to be sheared off and away from the frame. Therefore, it would be advantageous to have a skid or like device that is mountable over or around the body mount to protect it from damage.

### SUMMARY OF THE INVENTION

A body mount skid assembly may include a bracket and a skid plate. The bracket may be positioned on a body mount of a vehicle. The skid plate may then be positioned on the bracket to least partially enclose and protect the body mount. The body mount skid assembly and its constituent parts may be constructed of steel. However, other metals, alloys, synthetic or composite materials (or combinations thereof) that have the requisite strength characteristics may also be used in the construction of the body mount skid assembly. This application claims priority from pending U.S. Provisional Application No. 60/655,788, filed on Feb. 24, 2005 for a Body Mount Skid Assembly, the disclosure of which is incorporated in its entirety into this application.

### BRIEF DESCRIPTION OF THE DRAWINGS

Reference will now be had to the attached figures wherein like reference numerals refer to like parts throughout and wherein:

FIG. 1 is an exploded perspective view of an embodiment of a body mount skid assembly;

FIG. 2 is a planar front view of the embodiment of a body mount skid assembly shown in FIG. 1;

FIG. 3 is an exploded perspective view of another embodiment of a body mount skid assembly; and

FIG. 4 is a partial, planar front view of the embodiment of a body mount skid assembly shown in FIG. 3.

### DESCRIPTION OF THE INVENTION

A body mount skid assembly may include a bracket and a skid plate. The bracket may be positioned on a body mount of a vehicle. The skid plate may then be positioned on the bracket to least partially enclose and protect the body mount. The body mount skid assembly and its constituent parts may be constructed of steel. However, other metals, alloys, synthetic or composite materials (or combinations thereof) that have the requisite strength characteristics may also be used in the construction of the body mount skid assembly.

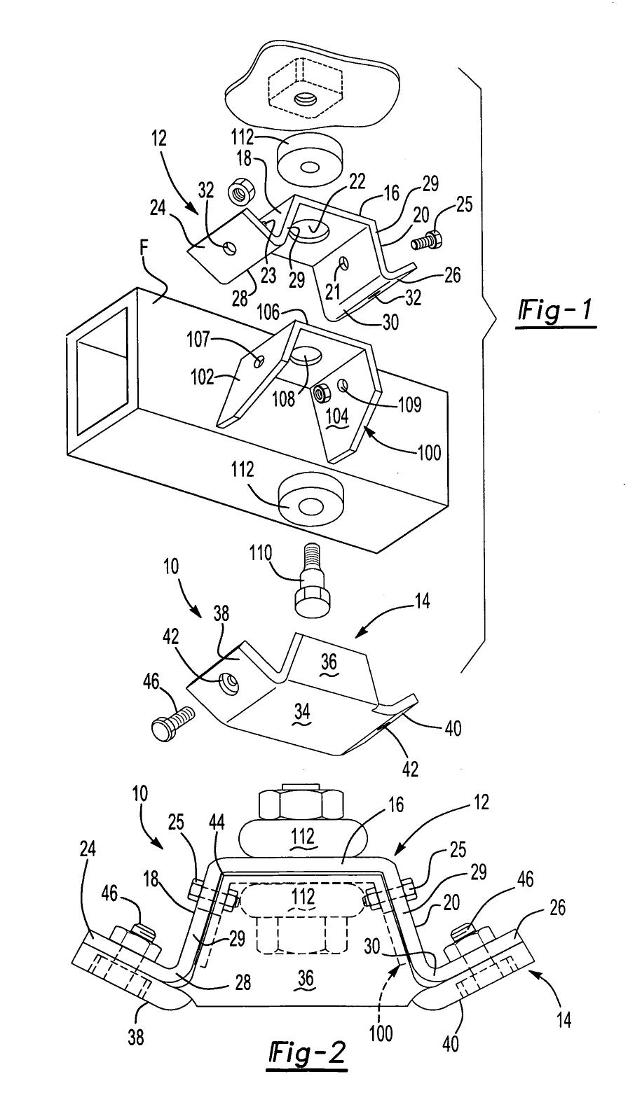

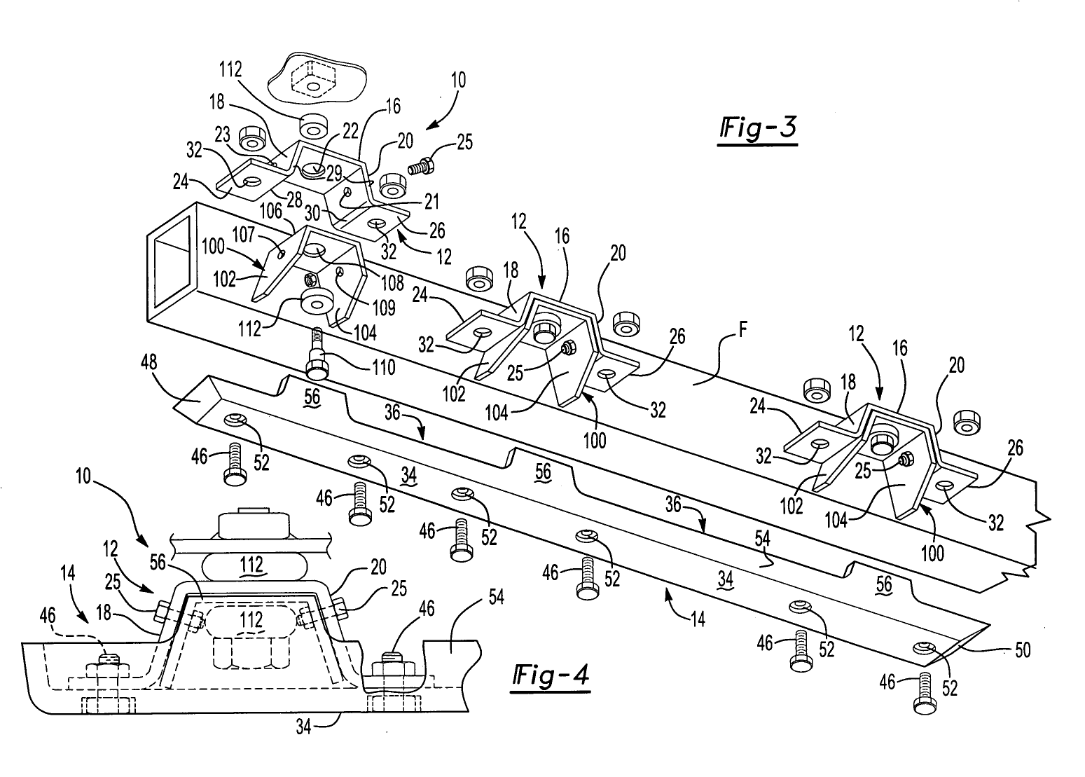

Referring now to FIGS. 1-4, a body mount skid assembly 10 may include a bracket 12 and a skid plate 14. The bracket 12 may be positioned on (or otherwise engage) a body mount 100 that is positioned on and extends from a frame “F” of a vehicle (not shown). The skid plate 14 may be positioned on the bracket 12 to at least partially enclose and protect the body mount 100. As shown in FIGS. 1 and 2, a body mount skid assembly 10 may be designed to fit around and protect a single body mount 100. However, as shown in FIGS. 3 and 4, a body mount skid assembly 10 may also be designed to fit around and protect more than one body mount 100.

Referring now to FIGS. 1 and 2, as mentioned above, the bracket 12 of the assembly 10 may be positioned on a body mount 100 for a vehicle. The bracket 12 may have a center portion 16 and a pair of opposed sidewalls 18, 20 that, with the center portion 16, may give the bracket 12 a generally U- or channeled shape. The sidewalls 18, 20 may also be constructed to be complementary with the sides 102, 104 of the body mount 100 so that sidewalls 18, 20 of the bracket 12 may be easily positioned on the mount 100. Specifically, the sidewalls 18, 20 of the bracket 12 may be constructed such that the sidewalls 18, 20 may engage or otherwise abut the sides 102, 104 of the body mount 100. As such, it will be appreciated that the sidewalls 18, 20 may be constructed to extend substantially perpendicular to a plane of the center portion 16 or, alternatively, may be constructed so as form an acute or obtuse angle with regard to the plane of the center portion 16.

Still referring to FIGS. 1 and 2, an aperture 22 may be defined through the center portion 16 of the bracket 12. As best shown in FIG. 2, the center portion 16 of the bracket 12 may be positioned on an upper surface 106 of the body mount 100. Further, when the bracket 12 is positioned on the body mount 100, the aperture 22 of the bracket 12 may be aligned with an aperture 108 in the body mount 100 for later securing, as will be described, of the bracket 12 to the body mount 100 by means of a fastener 110. Further, additional apertures 21, 23 may be defined in the sidewalls 18, 20. As shown, when the bracket 12 is positioned on the body mount 100 the apertures 21, 23 may be aligned with apertures 107, 109 that are defined in the sides 102, 104 of the body mount 100. A fastener 25 (a bolt and nut) may then be extended through the apertures 21, 107 and 23, 109 to thereby secure the sidewalls 18, 20 to the sides 102, 104 of the body mount 100.

Still referring to FIGS. 1 and 2, a flange 24, 26 may extend from an end 28, 30 of each of the sidewalls 18, 20 of the bracket 12. Further, each flange 24, 26 may be angled (or bent or otherwise flared) relative to the center portion and/or its respective sidewall 18, 20. For example, as shown in FIGS. 1 and 2, each flange 24, 26 may be angled upwardly toward the center portion 16 so as to form an acute angle between the flange 24, 26 and its respective sidewall 18, 20. However, as will be discussed below, each flange 24, 26 may also be constructed such that it extends parallel to the plane of the center portion 16 or, alternatively, so that is creates an obtuse angle with respect to the sidewall 18, 20. The sidewalls 18, 20 may also have a length at one end (which may be positioned proximate the frame F) that is greater than the length of the opposite end 29 (which may be positioned away from the frame F). As a result, each flange 24, 26 may be angled upwardly (as the flange 24, 26 extends away from the frame F) rather than being parallel to the ground (not shown) or perpendicular to the frame F.

Still referring to FIGS. 1 and 2, each flange 24, 26 of the bracket 12 may also include at least one aperture 32 for use in securing the skid plate 14 to the bracket 12 as will be described below. In this regard, the aperture 32 may be threaded, or a recess (now shown) may be defined around the aperture 32 suitable for retaining a nut and washer. The area around the aperture 32 may also be constructed without a recess.

Still referring to FIGS. 1 and 2, the skid plate 14 of the assembly 10 may include a middle (or base) portion 34, a front flange 36, and a first end flange 38 and a second end flange 40. The end flanges 38, 40 may extend from opposite sides of the middle portion 34. The front and end flanges 36, 38, 40 of the skid plate 14 may also extend at an angle away from the middle portion 34 of the skid plate 14. Specifically, as shown, the front and end flanges 36, 38, 40 may angle upwardly from the middle portion 34 such that, when the skid plate 14 is positioned on the bracket 12, the end flanges 38, 40 may engage the flanges 24, 26 of the bracket 12. Each end flange 38, 40 of the skid plate 14 may further include an aperture 42 that may be aligned with the apertures 32 of the flanges 24, 26 of the bracket 12 when the skid plate 14 is positioned on the bracket 12.

As best shown in FIG. 2, when the skid plate 14 is positioned on a bracket 12, the end 44 of front flange 36 may extend towards and terminate proximate the center portion 16 of the bracket 12. Accordingly, the skid plate 14 may cooperate with the bracket 12 to surround or at least partially enclose the body mount 100 in a protective enclosure. Further, the visible exterior of this “enclosure” (i.e., the skid plate 14) may be angled to aid in the deflection of objects encountered by the vehicle that might otherwise damage the body mount 100.

Still referring to FIGS. 1 and 2, as mentioned above, in operation the bracket 12 may be mounted on the body mount 100. Rubber bushings 112 may then be positioned below the body mount 100 and above the bracket 12 to function as spacers and to assist in the proper mounting of the vehicle. Thereafter, a fastener 110, such as a bolt, may be extended through the bushings 112 and the apertures 22, 108 of the center portion 16 and the body mount 100 to secure the bracket 12 in position on the body mount 100 (and to secure the vehicle body to the body mount 100). The skid plate 14 may then be fitted to the bracket and fasteners 46 extended through the apertures 32, 42 to removably secure the skid plate 14 to the bracket 12.

Referring now to FIGS. 3 and 4, another embodiment the body mount skid assembly 10 may include two or more brackets 12, mounted on different body mounts 100, and a skid plate 14 that has been lengthened so that it may be secured to the brackets 12 and may also cover any body mounts 100. The bracket 12 may be constructed as described above. However, as best shown in FIG. 4, when an elongated skid plate 14 is utilized, the flanges 24, 26 of one or more of the brackets 12 may be constructed such that the flanges 24, 26 extend parallel to the plane of the center portion 16 to thereby create a planar surface to which the skid plate 14 may be secured. However, it will also be appreciated that the flanges 24, 26 may also be angled as necessary in any fashion relative to the center portion 16 or sidewalls 18, 20 in order to facilitate securing of the skid plate 14 to each bracket 12.

Still referring to FIGS. 3 and 4, the skid plate 14 of the assembly 10 may include a middle (or base) portion 34, a front flange 36, and a first end 48 and a second end 50. As shown, the middle portion 34 may include a plurality of apertures 52 that may be aligned with the apertures 34 of the flanges 24, 26 of the brackets 12. Accordingly, similar to the above, a single skid plate 14 may be secured to each of the brackets 12 by the use of fasteners 46 that extend though the apertures 32, 52 of the skid plate 14 and the brackets 12.

Finally, still referring to FIGS. 3 and 4, the front flange 36 may include a wall 54 that extends along at least part of the length of the skid plate 14. Further, the height of the wall 54 may be adapted to meet the needs of the user. Specifically, the height of the wall 54 may be higher in sections 56 where the wall 54 would extend proximate a body mount 100 and may be lower along other sections to allow a user to insert tools (or the like) behind the wall to facilitate the placement or securing of fasteners (e.g., the tightening of bolts on the flanges, etc.) As best shown in FIG. 3, each end 48, 50 of the skid plate 14 may also be angle upwardly (i.e., toward the vehicle (not shown) when a plate 14 is mounted in position) to enclose the row/array of body mounts 100 and thereby assist in the deflection of terrain and other obstacles away from direct contact with the body mount 100.

Having thus described my invention, various other embodiments will become known to those having skill in the art that do not depart from the spirit of the invention.

I claim:

1. A body mount skid assembly comprising:
a bracket having a center portion, a first and a second sidewall that extend from the center portion and a first and a second side flange that extend from each sidewall;
a skid plate having a base and a front flange that extends from the base, the skid plate being securable to the bracket; and
whereby the bracket and the skid plate operate to at least partially enclose a body mount of a vehicle.

2. The body mount skid assembly of claim 1, wherein the skid plate further comprises a first end flange and a second end flange, each end flange extending from an opposite side of the base and being securable to a side flange of the bracket.

3. The body mount skid assembly of claim 2, wherein each end flange of the skid plate is angled with respect to the base.

4. The body mount skid assembly of claim 1, wherein the skid plate further comprises an elongated skid plate securable to at least two brackets.

5. The body mount skid assembly of claim 4, wherein the front flange of the skid plate further comprises a wall.

6. The body mount skid assembly of claim 5, wherein the wall extends along at least part of a length of the skid plate.

7. The body mount skid assembly of claim 6, wherein the wall is higher at sections that extend proximate a bracket.

8. The body mount skid assembly of claim 4, wherein the skid plate further comprises a pair of ends, each end being angled upwardly.

9. The body mount skid assembly of claim 1, wherein the first and the second sidewalls are angled with respect to the center portion.

10. The body mount skid assembly of claim 1, wherein the first and the second flanges are angled with respect to the center portion.

11. The body mount skid assembly of claim 1, wherein the center portion of the bracket includes an aperture defined therethrough.

12. A body mount skid assembly comprising:
at least two brackets, each bracket having a center portion, a first and a second sidewall that extend from the center portion and a first and a second side flange that extend from each sidewall;
a skid plate having a base and a front flange that extends from the base, the skid plate being securable to each bracket of the at least two brackets; and
whereby the brackets and the skid plate operate to at least partially enclose at least two body mounts of a vehicle.

13. The body mount skid assembly of claim 12, wherein the front flange of the skid plate further comprises a wall.

14. The body mount skid assembly of claim 13, wherein the wall extends along at least part of a length of the skid plate.

15. The body mount skid assembly of claim 14, wherein the wall is higher at sections that are proximate a bracket.

16. The body mount skid assembly of claim 12, wherein the first and the second sidewalls are angled with respect to the center portion.

17. The body mount skid assembly of claim 12, wherein the first and the second flange are parallel to the center portion.

18. The body mount skid assembly of claim 12, wherein the center portion of the bracket includes an aperture defined therethrough.

19. A body mount skid assembly comprising:
a bracket having a center portion, a first and a second sidewall that extend from the center portion and a first and a second side flange that extend from each sidewall and that are angled with respect to the center portion; and
a skid plate having a base, a front flange that extends from the base and a first end flange and a second end flange, each end flange extending from an opposite side of the base and being securable to a side flange of the bracket;
whereby the bracket and the skid plate operate to at least partially enclose a mount body of a vehicle.

20. The body mount skid assembly of claim 19, wherein the center portion of the bracket includes an aperture defined therethrough.
